(19) United States
(12) Patent Application Publication
(10) Pub. No.: US 2014/0260903 A1
(43) Pub. Date: Sep. 18, 2014

(54) SYSTEM, PLATFORM AND METHOD FOR DIGITAL MUSIC TUTORING

(71) Applicant: LIVETUNE LTD., Jerusalem (IL)

(72) Inventor: Jacob STOK, Hod HaSharon (IL)

(73) Assignee: LIVETUNE LTD., Jerusalem (IL)

(21) Appl. No.: 14/212,500

(22) Filed: Mar. 14, 2014

Related U.S. Application Data
(60) Provisional application No. 61/787,664, filed on Mar. 15, 2013.

(51) Int. Cl. G09B 15/00

(52) U.S. Cl. CPC G09B 15/002
USPC 84/477 R

(57) ABSTRACT

A system, platform, method and application are herein provided for digital music tutoring. In some embodiments the platform includes a digital device equipped with a microphone; a library of music lessons available for presentation on the digital device; a graphical user interface adapted to allow a user to select a lesson from the library and present the selected lesson on the digital device; and an analytic module adapted to analyze a signal from the microphone produced by performance of the selected lesson and provide feedback to the user concerning the performance on the digital device.

This application claims the benefit of U.S. provisional patent application No. 61/787,664, filed Mar. 16, 2013, which is hereby incorporated by reference herein in its entirety.

### FIELD OF THE INVENTION

The invention is in the field of music education.

### BACKGROUND

The digital revolution of recent years has turned entire industries on their faces (eg. distributing music and movies) and is making significant changes in other industries (eg TV, payments). The music learning market has changed significantly in the last decade. Today, tens of millions of users learn to play a musical instrument using the Internet and Mobile applications installed on smartphones and tablets. Studying of music today is mainly through websites and applications that offer digitalized “sheet music”, and demonstration video of professional musicians.

Today, there are thousands of applications in online stores that provide music learning tools. For example, analysis of the sales data from the last 4 months of the three leading players (Songsterr, Apple, Ultimate Guitar) show that more than a million users have downloaded apps (paid) related to learning to play music.

### SUMMARY OF THE INVENTION

One aspect of some embodiments of the invention relates to a graphical user interface (GUI) which provides instructional feedback to a person making music (e.g. by singing or playing a musical instrument). In some embodiments, the GUI provides specific exercises and critiques the user's performance of those exercises.

Another aspect of some embodiments of the invention relates to a computerized server which analyzes queries containing musical passages and responds by providing instruction as to how to improve the musical passages from a technical standpoint. According to various exemplary embodiments of the invention, the instructions are provided as vocal instructions and/or graphically and/or as text instructions.

It will be appreciated that the various aspects described above relate to solutions of technical problems related to providing timely feedback to a music student performing an exercise.

Alternatively or additionally, it will be appreciated that the various aspects described above relate to solution of technical problems related to maintaining motivation and/or interest of a music student in performing lessons.

### BRIEF DESCRIPTION OF THE DRAWINGS

The principles and operation of the system, apparatus, and method according to the present invention may be better understood with reference to the drawings, and the following description, it being understood that these drawings are given for illustrative purposes only and are not meant to be limiting, wherein:

FIG. 1 is a schematic diagram of a system according to some exemplary embodiments of the invention;

FIG. 2 is a screenshot showing an example of the system tracking a user's performance using selected lessons/songs;

FIG. 3 is a simplified flowchart of a method according to some embodiments of the invention.

FIGS. 4A-4I are screenshots illustrating features of a user interface according to various exemplary embodiments of the invention; and

FIGS. 5A-5F are additional screenshots illustrating further features of a user interface according to various exemplary embodiments of the invention.

It will be appreciated that for simplicity and clarity of illustration, elements shown in the drawings have not necessarily been drawn to scale. For example, the dimensions of some of the elements may be exaggerated relative to other elements for clarity. Further, where considered appropriate, reference numerals may be repeated among the drawings to indicate corresponding or analogous elements throughout the serial views.

### DETAILED DESCRIPTION OF THE INVENTION

The following description is presented to enable one of ordinary skill in the art to make and use the invention as provided in the context of a particular application and its requirements. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In other instances, well-known methods, procedures, and components have not been described in detail so as not to obscure the presented embodiments of the invention.

### Exemplary System

FIG. 1 is a schematic representation of a system or platform for music education according to some embodiments of the invention, indicated generally as system 100. Depicted exemplary system 100 includes a digital device 110 equipped with a microphone 112 and a library 120 of music lessons available for presentation on digital device 110 via a graphical user interface 115 adapted to allow a user to select a lesson from library 120 and present the selected lesson on screen 116 of digital device 110. Depicted exemplary system 100 includes an analytic module 130 including code adapted to analyze a signal 113 from microphone 112 produced by performance of the selected lesson and provide feedback 114 to the user concerning said performance on digital device 110 (e.g. graphically on screen 116). In the depicted exemplary embodiment, library 120 of music lessons is stored on a remote server 140. Alternatively or additionally, library 120 of music lessons is stored on digital device 110 in some cases (not depicted). Alternatively or additionally, in some embodiments analytic module 130 resides on remote server 140 (not depicted). In the depicted exemplary embodiment, analytic module 130 resides on digital device 110.

In some embodiments, analytic module 130 includes a signal filter, a signal characterization module and a signal confirmation module. Alternatively or additionally, in some embodiments feedback 114 includes graphics and/or text and/or audio and/or video. In some exemplary embodiments of the invention, feedback 114 is presented rapidly enough that the user can implement suggestions during the lesson.

### Exemplary Method

FIG. 3 is simplified flow diagram of a method for music education according to some embodiments of the invention indicated generally as method or process 300. Depicted exemplary method 300 includes employing at step 310 a CPU to analyze an audio output signal from a microphone produced by performance of a selected musical passage by a user and providing at step 320 feedback to the user within a short interval, for example one minute or less, of conclusion of the performance, via a digital device. In some embodiments, the feedback includes an analysis at step 322 of the performance. Alternatively or additionally, in some embodiments the feedback includes generating advice at step 324 about improving a subsequent performance of the selected musical passage. In some cases the method includes requiring the user to perform the selected musical passage again to implement advice 324 (not depicted). In some embodiments, the CPU at 320 analyzes by comparison to characteristics of a theoretically perfect performance of the selected musical passage.

### Exemplary Digital Device

Referring again to FIG. 1, some exemplary embodiments of the invention relate to digital device 110 adapted to function as a music tutor that provides feedback on a student's performance during the performance. According to various exemplary embodiments of the invention the digital device is selected from the group consisting of a computer, a smart TV, a tablet computer and a smartphone.

### Exemplary Advantages

Described embodiments of the invention contribute to interactivity of the music education experience. Advanced signal processing allows a machine to “understand” what the user is currently playing and provide timely feedback to help the user improve.

Described embodiments of the invention contribute to an ability of digital devices to “listen” to a musical passage played by a user, “understand” what was played (notes, chords, melody form and manner, etc.) and transmit feedback during the playing session, substantially in real time.

Described embodiments of the invention are useful in bringing music education to the digital era and creating a new experience for learning and practicing musical instruments. A software engine is provided that “understands” musical instruments. The fundamental output of the engine is a unique signature of very small audio chunks that may be used to analyze music/musical instruments/voice. In some embodiments, the signature holds a unique identifier of the signal's harmonics that may be connected with the specific engine output. For a different signal, a different harmonic signature will be created. For example an Am chord may get a signature of “XXX” and a Bm chord may get a signature of “YYY”.

Described embodiments of the invention are flexible in their implementation and provide a platform that may be accessed via a web-browser and/or smart phone and/or tablet and/or smart TV. In some embodiments, the platform uses the microphone installed on the user's chosen device (e.g. tablet or smartphone) to capture the sound of the musical passage.

In some embodiments the system or platform enables learning and practicing musical instruments from a digital device (i.e. computer, TV, phone, tablet) by providing real-time feedback to what a user plays.

In accordance with some embodiments of the present invention, the music learning system may include an application comprising an interactive play feature that can run on any platform including a WWW browser and digital operating systems such as tablets and mobile phones (e.g. ANDROID, IOS, WINDOWS MOBILE and BLACKBERRY). The application may include three primary layers: An interface layer: responsible for “drawing” characters, audio playback and adjusting desired characters with user input; An engine layer for signal analysis, which enables receipt and processing of polyphonic musical notes from the user's instrument, to deliver data substantially in real time to the interface layer; and a polyphonic detection engine. For example, the GUI may “render” a set of notes and chords synced with a lesson playback. In another example, the GUI may enable the user to adjust microphone parameters for fine-tuning.

The polyphonic detection engine layer may include one or more of: a signal filter, which functions as the operation and function “window” to filter out background noise and various disorders or problematic sounds; a Signal Characterization module, to help “understand” the filter beyond spacing, frequency, condensing information; a Signal confirmation module, for creating a single key for each signal value, which then is stored in the memory database and tested for character determination (e.g. a single note, chord, etc.); and a data collection and analysis layer.

The platform collects the user's musical character, type or profile, while the user is playing in order to enable an accurate and in-depth analysis of the performance, and to provide a variety of tools that will enable the user to further improve his/her performance. For example, the system may “record” a user's actions, such as which songs they played, which lessons they took, and determine how they played it. From analyzing all the users data, the system provides a function (e.g. A crowd based function) which can tell each user, based on his/her “path” what music should or may be played next. Also, from his/her course/lesson selection, the system can begin to understand a user's musical taste, which is also embedded in the recorded dataset.

The data collection and analysis layer collects the following information, including the notes/chords played by the user; the missed notes and chords; and the character of the recorded play (e.g. power, speed, etc.). With this data the system can generate a report on the user performance, and may recommend additional exercises to help him/her improve.

The system server is used in some embodiments to store the collection of lessons and courses and/or to store information about the specific users and their performances. In some exemplary embodiments of the invention, the server is cloud computer compatible, for example it may be stored on Amazon's cloud, and may store files on a Content Delivery Network (CDN) to enable rapid file download for a user no matter where in the world the user may be, and without burdening the server. The server manages users' information security needs, including management of passwords and connectivity with social networking.

In some embodiments, the system includes a Statistics subsystem for collecting user actions on the application, in order to generate detailed reports using content creators or generators such as the number of users who played the song, time played, and the nature of their music.

One technical problem solved by some embodiments of the invention is identifying characters and chords accurately in a short time with limited system resources. In addition, there is a delay (latency) between the sound card and application layer. Latency may refer to the amount of time that passes from the time that the microphone is captured by an analog signal to the time that this signal was converted into a digital signal and integrated into the app. In some embodiments, implementation of an algorithm contributes to a reduction in latency. For example, a latency reduction algorithm can provide a result based on a relatively-small dataset that is a subset of a single sample, thereby enabling an increase in response time for the user and hence a reduction in delay (i.e. latency). A chord is a number of characters played simultaneously. The playing of sound on an instrument consists of harmonic and other characters of different octaves. In addition, the signal varies almost completely over time due to the physical structure of the instrument, e.g. guitar and guitar strings—i.e. the character of the echo of the guitar strings. In addition to the “disturbances” or guitar signals themselves, there are also additional background noises and other disturbances due to converting the analog signal to digital. All these factors make it difficult to analyze and characterize the signal.

The described polyphonic detection engine addresses these problems during “runtime”, enabling rapid and accurate feedback in a time frame that emulates a private music lesson with a live teacher. In one example, the engine may output multiple parameters or options, such as: 1. If the user hit the right chord/note; 2. If the user's timing was good (i.e. if you played what you supposed to play on time); 3. How “clear” (e.g., harmonic) the tone was etc. These and other elements my be seen or function as gestures that a music teacher may use to give feedback and improve their student's performance.

In some embodiments, the system is implemented in the context of smart television and users learn the musical instrument of their choice in front of their television interactively.

The platform described above provides previously unavailable opportunities to music students that cannot afford to pay a tutor or do not have access to a tutor for other reasons (e.g. live in a remote area).

In some exemplary embodiments of the invention, an application includes a library of content (organized as lessons) at a variety of levels. In some embodiments, the lessons are geared for a variety of musical tastes (e.g. classical, jazz, rock and pop). In some exemplary embodiments of the invention the lessons are written by teachers of music and include professional feedback. For example, feedback may include video clips of a famous musician explaining how to avoid, or correct common mistakes likely to occur in the performance of a specific passage. Based upon analysis of the user's actual performance, the relevant video clip is presented as feedback. Alternatively or additionally, in some embodiments the application supports and monitors implementation of the program, the pace of progress and provides feedback rules. As can be seen in FIG. 2, the screenshot shows an example of the system tracking a user's performance using selected lessons/songs, and thereafter prompting, or otherwise supporting the user's progress within his/her courses, optionally providing customized feedback and/or guidance. As can be seen, a “user progress” interface shows which courses the user had taken, and what their progress level is etc.

In some exemplary embodiments of the invention, an expanded platform allows teachers to upload music lessons and request their inclusion in the course curriculum.

### Exemplary Supported Instruments

According to various exemplary embodiments of the invention, the system, platform, and/or application described above is employed in the context of study of guitar, piano, organ, brass, drums, and/or vocals. In some exemplary embodiments of the invention, a standard musical instrument is employed without the need for special hardware. In some embodiments, a user may change instruments by selecting from a menu.

### Exemplary Application Organization

In accordance with still further embodiments, the application may include three layers: 1) Signal Layer analysis and Polyphonic segmentation engine: This is the heart of the system. This fine layer signal may be the user's instrument's sound card, as accessed or input through the microphone of a digital device (e.g. tablet). The engine analyzes the digital signal and identifies characters and chords, and rapidly produces a sound sample mounted on a “window” to allow an initial quality indication to the user.

The engine may be divided into three main parts: a) Signal filter: filter operation and function “window” to avoid background noise, and various disorders; b) characterization of the signal: beyond space frequency, frequency and shrinking filter information; c) Signal fixing or signing: Creating a single key for each letter values, which then is memory database and tested character (e.g., a single note, chord, etc.).

2) Layer of data collection and analysis: The application collects the user's musical character while playing in order to give him an accurate and in-depth analysis of the performance, to provide the tools that will enable further improvement.

The data collection layer collects the following information: Notes/chords played by the user; Data success and missed notes and chords; Nature of the instrument (power, speed, etc.). With this data the user can generate a report on the performance and may recommend additional exercises to help him/her improve performance.

3) Interface layer: responsible for “drawing” characters, audio playback and adjusting desired characters with user input, rendering a set of notes and chords optionally synced with a lesson playback.

### Exemplary Server

In some exemplary embodiments of the invention, the application communicates with a remote server. The server stores the collection of lessons and courses as well as information about the users and their performance. In some embodiments, the server is stored on a “cloud” and stores files on a CDN to enable rapid file download to the user.

Embodiments of the invention allow digital devices to “listen” to the user play an instrument, “understand” what was played (notes, chords, form and manner of melody, etc.) and transfer professional feedback suitable for the playing, each process occurring in real time. In fact, this is a private virtual music teacher.

### Exemplary Use Scenarios

In a first example, as shown in FIG. 4A, the application consists of different courses at different levels so that each user can choose the appropriate course level. Screenshot shows the main screen of the application which has different courses.

In a second example, as shown in FIG. 4B, each course has a brief explanation of subject matter with level of difficulty and pace. Each course may be divided into classes or segments, using an interactive screen. The list of interactive lessons that belong to this class may be seen in the figure. There will typically be brief explanations provided as necessary by the system. Symbols may generally be marked with a hand, finger or otherwise, and data such as item ratings, specifications, grades data and user performance may be provided. The user, in some cases, may not move ahead to another lesson until the current lesson has been completed.

In a further example, as shown in FIG. 4C, a lesson begins a collection of user tips (Screen 3) that help him/her understand what s/he should do in the lesson. There may be technical requirements, as well as theoretical explanations for the patterns and to teach lessons.

In a further example, as shown in FIG. 4D, at the beginning of every lesson, a user may be prompted to set up his/her guitar (total 4). For example, the application prompts the user to tune his/her voice and/or instrument to ensure the voice/instrument are appropriately set up, so that the lesson can be started when the user and instrument are appropriately set up.

In a further example, as shown in FIG. 4E, screen can be seen in the interactive lesson in action, where characters are represented by bubbles shifting from the right to left of the screen. Each bubble may contain a number or other symbol that indicates the lattice on the neck of the guitar, to guide the user to select one or more lessons to play, for example, using a finger to paint a bubble's color according to which finger should strum. Accordingly, a user should strum her/his guitar when each bubble reaches the ‘most targeted’ area (e.g., a gray rectangle at the left of the screen).

In a further example, as can be seen in FIG. 4F, screen shows an example of “correcting” the character, for example, by showing an improvement in the status (e.g., color, format, behavior etc.) of the trail points to indicate levels of success or progress. On the right side of the screen there are colorful prints or other graphical symbols on the strings, to help the user understand where and what fingers to press the frets.

In a further example, as can be seen in FIG. 4G, display shows the rate in training, by using a timer that waits for the user to hit a successful note/chord, or in accordance with pre-set intervals etc. As can be seen, the bubbles may stop in front of the target while the application waits until the user successfully completes the character or chord. In some examples the application may track the engine determine the user's tempo or other characteristics, and compute the interval between different notes/chords that the user is playing, to help adjust a practice mode or session to the user. In this way, the user and adapts itself to him/her, for example, displaying his/her training status. In some examples, the application may provide the user with guidelines during performance, and even prior to the performance of notes/characters etc., to help the user figure out how to optimally perform, substantially in real time. In some examples: 1) The app may provide a “preview” that can enable the user to hear the performance before s/he plays it 2) The app may provide a practice mode lesson before every “regular” lesson to ease the learning process of new material. 3) The app may provide tips before every lesson that emphasize the important elements in the lesson. 4) While in a lesson, the app may provide textual feedback that is correlated to the users' performance.

In a further example, as can be seen in FIG. 4H, an end-user is rated by the amount of notes and chords played correctly. Depending on the score, the user may be invited to move to the next lesson, or asked to repeat the lesson. In some embodiments, users are invited to share their progress on a social network.

### Exemplary Interaction Between Artists and Students

In some embodiments, artists that want to promote their music are invited to participate in preparation of lessons and relevant feedback. An example of an invitation to participate in lessons produced in this way is presented in FIG. 4I. The screen consists of the band's promotional material, a video showing the app in action and scoreboard showing the users who have accumulated the most points.

At (10) one can see the app in action in the background, such that original song of the band can be heard in the background, and the bubbles represent the notes and chords of the guitar part of that song (i.e. representing the guitar sheet-music of this song) in the guitar song. It is noted that all colors and promotional materials of the band can be changed easily by changing the CSS file.

Reference is now made to FIGS. 5A-5F, which show additional screenshots illustrating further features of a user interface according to various exemplary embodiments of the invention. As can be seen in FIG. 5A, a Marketplace type page is shown, indicating the course(s) that the user can choose from. Each course may include Lessons about chords, scales and rhythm and also popular content. As can be seen in FIG. 5B, a Lesson is shown in practice mode, where the system waits for the user to play the right note. As can be seen in FIG. 5C, a further Lesson in practice mode is shown, where the user missed the chord. As can be seen in FIG. 5D, in a further Lesson mode, the notes are mapped into colored bubbles with numbers. As can be seen in FIG. 5E, a Tuner Mode is depicted, to help the user calibrate his/her guitar tune. As can be seen in FIG. 5F, a further Lesson mode is depicted, that shows how an example of feedback may look. This image shows that the user has played the correct chords. Of course, these above screenshots are only examples, and many other features, graphics, processes etc. may be used.

The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

What is claimed is:

1. A teaching system comprising:
(a) a digital device equipped with a microphone;
(b) a library of music lessons available for presentation on said digital device
(c) a graphical user interface adapted to allow a user to select a lesson from said library and present said selected lesson on said digital device;
(d) an analytic module adapted to analyze a signal from said microphone produced by performance of said selected lesson and provide feedback to said user concerning said performance on said digital device.

2. A system according to claim 1, wherein said library of music lessons is stored on at least one of a remote server and said digital device.

3. A system according to claim 1, wherein said analytic module resides on a remote server.

4. A system according to claim 1, wherein said analytic module resides on said digital device.

5. A system according to claim 1, wherein said analytic module includes a signal filter configured to filter out background noise and disorders from the signal, a signal characterization module configured to help “understand” the filter beyond spacing, frequency, condensing information and a signal confirmation module configured to create a single key for each signal value and test the single key for character determination.

6. A system according to claim 5, wherein said analytic module further includes a data collection and analysis layer configured to collect the notes/chords played by the user; the missed notes and chords, and the character of the signal.

7. A system according to claim 1, further comprising an interface module configured to display the graphical user interface including musical characters, audio playback and adjusting desired characters with user input.

8. A system according to claim 5, wherein said analytic module further includes an engine module for signal analysis, which enables receipt and processing of polyphonic musical notes from the user's instrument, to deliver data substantially in real time to the graphical user interface.

9. A system according to claim 1, further comprising a statistics module configured to collect user actions, in order to generate detailed reports such as the number of users who played the selected lesson, time played, and the nature of their music.

10. A system according to claim 1, wherein said feedback comprises at least one of graphics, text, audio, and video.

11. A system according to claim 1, wherein said feedback is presented rapidly enough that the user can implement suggestions during the lesson.

12. A music training method comprising:
(a) employing a CPU to analyze an audio output signal from a microphone produced by performance of a selected musical passage by a user; and
(b) providing feedback to said user within a selected interval of conclusion of said performance via a digital device.

13. A method according to claim 12, wherein said feedback includes an analysis of said performance.

14. A method according to claim 13, wherein said feedback comprises video addressing a certain error common to the selected musical passage that has been detected in the audio output signal analysis.

15. A method according to claim 12, wherein said feedback includes advice about improving a subsequent performance of said selected musical passage.

16. A method according to claim 12, wherein said CPU analyzes said audio output signal by comparison to characteristics of a theoretically perfect performance of said selected musical passage.

17. A method according to claim 12, further comprising displaying an image of a portion of a guitar including portions of the strings and, based on the selected musical passage, displaying graphics moving along the strings that indicate a user is to strum the string the graphic is on when the graphic passes through an indicated area, wherein the graphics are color-coded to indicate what finger the user is to use to strum the string, further comprising graphic color-coded indicators of where the user is to place the user's fingers on frets of the guitar, all to enable the user to play the selected musical passage.

18. The method of claim 17, further comprising stopping the movement of the graphics along the strings when a user does not strum when indicated, and beginning the movement of the graphics again when the indicated strumming is completed by the user.

19. A digital device adapted to function as a music tutor that provides feedback on a student's performance during the performance, the device comprising:
(a) a microphone;
b) a library of music lessons available for presentation on the digital device;
(c) a graphical user interface adapted to allow a user to select a lesson from said library and present said selected lesson on the digital device;
(d) an analytic module adapted to analyze a signal from said microphone produced by performance of said selected lesson and provide feedback to said user concerning said performance on the digital device.

20. A digital device according to claim 19, selected from the group consisting of a computer, a smart TV, a tablet computer and a smartphone.
